(19) United States
(12) Patent Application Publication
(10) Pub. No.: US 2011/0231645 A1
(43) Pub. Date: Sep. 22, 2011

(54) SYSTEM AND METHOD TO VALIDATE AND AUTHENTICATE DIGITAL DATA

(76) Inventors: Alun Thomas, Buckinghamshire (GB); Bradley Geppert, Northwood (GB); David Pilfold, Malvern (GB); Ray Nightingale, Munchengladbach (DE)

(21) Appl. No.: 12/514,013

(22) PCT Filed: Nov. 6, 2007
(86) PCT No.: PCT/US07/83769

§ 371 Date: Mar. 30, 2011

(30) Foreign Application Priority Data
Nov. 7, 2006 (GB) 0622149.3

(51) Int. Cl. G06F 21/00; H04L 9/32

(52) U.S. Cl. 713/150; 726/26

(57) ABSTRACT

A system and method combining registration with a trusted third party, certificate generation, hashing, encryption, customizable file identification fields, and time-stamping technology with recognized “best practice” procedures to achieve the legal admissibility and evidential weight of any form of digital file or collection of digital files. Generally, the originator of the file (the first party) and the originator's employing organization are registered with a Trusted Third Party. The originator reduces the file, by means of a hashing algorithm, to a fixed bit length binary pattern. This provides a unique digital fingerprint of the file. The resultant hash value, the originator's identity details, the employing organization details associated and securely linked to the digital certificate, the title of the file, customizable file identification fields, and other relevant data are forwarded to a Trusted Third Party where the date and time from a known and trusted time source are added. The customizable file identification fields can provide the originator with a mechanism for configuring the seal to incorporate as much additional information as deemed necessary to prove the authenticity of the digital content and/or provide data for the purposes of adding value in functions such as source identification, sorting, analysis, investigation, and compliance. Such information could include, but would not be limited to, location/GPS coordinates, machine id, biometric information, smart-card data, reason for sealing. The original file does not leave the control of the originating party. When combined, the forwarded details and date and time create a Seal Record. The Seal Record is encrypted and hashed. The Seal Record along with all other relevant information are retained on a central secure server. The recipient of the file (the second party) can confirm the file has been received in an unaltered state with integrity retained and it is the authentic version by validating the file.

### TECHNICAL FIELD

The present invention relates generally to a system and method to validate and authenticate digital data and, in particular, to a system and method to validate and authenticate digital data utilizing time-stamping, hashing techniques, digital certificates, a trusted third-party, and additional security mechanisms.

### BACKGROUND OF THE INVENTION

Technological advances in electronic data duplication and dissemination has proliferated the transfer and exchange of digital content including, but not limited to, electronic documents, software, images, audio, video, and other digitized information. These technological advances, such as the Internet, have greatly enabled electronic commerce (“eCommerce”), thereby promoting effective business transactions. For example, the booking of an airline ticket, quotation for vehicle insurance, and the dispatch of an invoice for rendered service by electronic means have become common activities. Indeed, the Internet is now considered to be an integral part of the day-to-day life of many businesses and most governments consider it to form part of a critical national infrastructure.

The ability to provide almost instant access to information to millions of users has revolutionized the conduct of many businesses. For example, the expanded use of the Internet for eCommerce purposes provides the advantages of not having to store, retrieve, print, and dispatch large volumes of paper-based transactions. Data files can be retained in their native digital format and managed electronically at minimal expense.

It is well known to those skilled in the art, however, that electronic data can be easily corrupted, that secure systems connected to a network can be attacked and breached potentially causing subsequent corruption of stored data, and that users can provide corrupted and malicious data that appears to be from a trusted source to unsuspecting recipients. Current users of electronic data received from various sources are unable to verify that the data received is valid or whether the data is from a particular source. Because of the uncertainty of some data transferred or accessed electronically, many users perceive electronic data to be unsafe or unreliable. Further, the sophistication of software applications enabling a user to create, change, or otherwise misrepresent data, whether maliciously or inadvertently, provides for potential fraudulent or illegal use of data transactions.

Traditionally there has been reluctance in the industry to accept electronic data as a genuine article (i.e., a more tangible and reliable medium such as paper). Not surprisingly, preference still exists for a “wet signature” on important documents; that is real ink on a physical piece of paper.

The British Standards Institute began work on a best practice policy known as the Codes of Practice upon recognizing that there was a significant growth in electronic based transactions, but a persisting preference for paper-based documents when more important transactions or information were involved. The Codes of Practice focused on providing best practice policies and procedures for securing, validating, and authenticating digital data. Moreover, the Codes of Practice provide procedures to ensure that particular digital content retains legal admissibility and evidential weight by utilizing suitable technology that can prevent corruption of data and/or recognize when data has been tampered with. These Codes of Practice may very well form the basis of a new International Standards Organization (ISO) standard in the coming years.

Early technical approaches to verifying the integrity of electronic data focused on verifying the data in a bilateral communications environment. In such an environment, the sender of the document desires to verify to the receiver of a document, the source and original content of the transmitted document. Such approaches used private-key cryptographic schemes for message transmission between a limited universe of individuals who are known to one another and who alone know the decrypting key. Encryption of the message ensures against tampering, and the fact that application of the private key reveals the “plaintext” of the transmitted message serves as proof that the message was transmitted by an individual in the defined universe. Private-key encryption, however, is limited to users that have already established a trust with each other. Accordingly, use of a private key is fairly limited in an environment that includes data transactions between or accessed by unfamiliar or unverified parties.

Unfortunately, conventional technologies for securing, authenticating, and validating digital content may not reflect the best practice policies and procedures or the security standards as outlined by the British Standards Institute, International Standards Organization, and American National Standards Institute. Indeed, a number of established technologies that are currently available have usage limitations. For example, digital or electronic signatures include potential problems with certificate life-span; time-stamping is often conducted without reference to an irrefutable time source; and independent trusted third parties or time-stamping authorities often are implemented without an adequately secure environment.

Although the following patents are potentially adequate for their intended purposes, current authenticating and validating technologies lack important safeguards to ensure that the digital content cannot be altered without detection.

What is needed, therefore, is a system and method to validate and authenticate digital data utilizing time-stamping, hashing techniques, digital certificates, a trusted third-party, and additional security mechanisms.

Additionally, such a system and method should be not be restricted to a traditional, transaction-based solution where communication between two or more parties is involved, but can also be deployed where sealing, validation, and extraction can be carried out with human intervention as part of a workflow methodology. It is to such a system and method that the present invention is primarily directed. As a comprehensive solution, the present invention contains all the safeguards needed to ensure that a successful authentication of the digital content demonstrates the legal admissibility and evidential weight of these contents.

One conventional authenticating and validating technology is disclosed in U.S. Pat. No. 5,022,080. A method and apparatus is provided for determining that a first unit of data associated with a first party has not been modified since a specified point in time. The method and apparatus includes, in a preferable hardware implementation, modification prevention from a particular point in time of multiple document file types, hashing, time-stamping, and hash value comparison for validation. U.S. Pat. No. 5,136,646 and U.S. Pat. No. RE34,954 disclose a system for time-stamping a digital document, for example any alphanumeric, video, audio, or pictorial data, that protects the secrecy of the document text and provides a tamper-proof time seal establishing an author's claim to the temporal existence of the document. The system generally includes the use of time stamping for multiple document file types, a tamper-proof time seal, hashing, public key certification, digital certificate production utilizing concatenation, receipt delivery, hash value comparison, a trusted time-stamp agency, and a multiple seal approach to prevent collusion and corruption activities.

U.S. Pat. No. 5,189,700 discloses a device to provide authenticated time includes a clock and an encryption circuit enclosed by a seal with a controller for producing an encrypted authentication code of the time read for the clock upon request. The device provides a hardware implementation utilizing various features such as authenticated time, an encryption circuit, hashing or complete text analysis, authentication code production, hash value comparison, while incorporating a user identity, device sequence number, and random number.

U.S. Pat. No. 5,373,561 discloses a cryptographic certificate attesting to the authenticity of original document elements, such as time of creation, content, or source, and will lose its value when the cryptographic function underlying the certifying scheme is compromised. The cryptographic certificate generally includes a process to lengthen the life of the certificate without changing the validity of the originally issued certificate.

U.S. Pat. No. 5,615,268 discloses a system and method that implements digital encryption for the electronic transmission, storage and retrieval of authenticated documents and that enables the establishment of the identity of the originator of an electronic document and of the integrity of the information contained in such a document. The system and method generally includes encryption and sealing by a certificate agency, authentication authority for validating seals, and audit trails.

U.S. Pat. No. 5,638,446 discloses a process for using a trusted third party to create an electronic certificate for an electronic file that can be used to establish the file and verify the identity of the creator of the file. The process includes application to multiple document file types, identifies and verifies the content creator, and utilizes a trusted third party registration, hashing, certificate generation with an identifier of the content creator, hash value comparison, file integrity maintenance, and public key encryption.

U.S. Pat. No. 5,689,567 discloses an electronic signature apparatus and method that provide an electronic signature that can be created only by a signer, but cannot be used for other than the signature object document to be processed, and that can be verified and authenticated as an image. The apparatus and method generally include signature image production, hashing, unique encryption using signature image, and hash value comparison.

U.S. Pat. No. 5,748,738 discloses methods and apparatus that implement digital signing and/or encryption for the electronic transmission, storage, and retrieval of authenticated documents and that enable the establishment of the identity of the originator of an electronic document and of the integrity of the information contained in such a document. The methods and apparatus generally include encryption and sealing by a certificate agency, authentication authority for validating seals, and audit trails.

U.S. Pat. No. 5,764,769 discloses an apparatus and method to produce a videotape or other recording that cannot be pre- or post-dated, or altered, or easily fabricated by electronically combining pre-recorded material. The apparatus and method is applied to video recordings and generally includes the incorporation of random data into an image to prove authenticity, thereby preventing the falsification of video images.

U.S. Pat. No. 5,781,629 discloses a process for time-stamping a digital document that provides a certificate which not only allows for the authentication of a document at a later time but which includes a name or nickname which allows for the unique identification of the document at a later time. The process generally includes time-stamping, unique identifier generation, and tree structure utilization.

U.S. Pat. No. 6,182,219 discloses an apparatus and method for authenticating that a sender has sent certain information via a dispatcher to a recipient. The apparatus and method generally include a dispatcher for sending data content, tamper resistance, hashing, hashing value comparison, and time component utilization for creation of a time-stamp.

U.S. Pat. No. 6,237,096 discloses methods and apparatus that implement digital signing and/or encryption for the electronic transmission, storage, and retrieval of authenticated documents and that enable the establishment of the identity of the originator of an electronic document and of the integrity of the information contained in such a document. The methods and apparatus generally include encryption and sealing by a certificate agency, authentication authority for validating seals, and audit trails.

U.S. Pat. No. 6,393,126 discloses a trusted time infrastructure system provides time stamps for electronic documents from a local source. The system applies to multiple document types and generally includes a trusted time system for time synchronization of a device, certificate production, public key encryption, and certification authentication.

U.S. Pat. No. 6,393,566 discloses a system and method for time-stamping and signing a digital document by an authenticating party and returning the signed stamped document to the originator or his designated recipient. The system and method, in a preferable hardware implementation and using a network layer approach, incorporates time-stamping, a digital signature, an authenticating party, time synchronization, hashing, and hash value comparison.

U.S. Pat. No. 6,553,494 discloses a method and apparatus whereby a person signs an electronic document using a personal biometric. The method and apparatus includes the use of biometric data to sign a digital document, whereby the data is encrypted with the document and other data to create a digital signature and the document is decrypted using the same biometric data.

U.S. Pat. No. 6,571,334 discloses an apparatus and method for authenticating that a sender has sent certain information via a dispatcher to a recipient. The apparatus and method generally include a dispatcher for sending data content, tamper resistance, hashing, hashing value comparison, and time component utilization for creation of a time-stamp.

U.S. Pat. No. 6,742,119 discloses a method for time stamping a digital document, wherein a document originator creates a time stamp receipt by combining the document and a digital time indication. The method applies to multiple document types and generally includes time-stamping from a trusted time-stamp agency, document and time component combination, time-stamp validation, and private signature key validation.

U.S. Pat. No. 6,792,536 discloses a smart card system and methods for proving dates of digital data files and includes a trusted time source. The system and methods, in a preferable hardware implementation, generally include a trusted time source linked to a hash value of digital content.

U.S. Pat. No. 6,895,507 discloses a system and methods for proving dates of digital data files, which are accessed, created, modified, received, or transmitted by a computer and includes a trusted time source in a tamperproof environment. The system and methods apply to multiple document types and include an unalterable trusted time source, temporal storing of digital content, digital signature, hashing, and certificate production.

U.S. Pat. No. 6,898,709 discloses a personal computer (PC) system and methods for proving dates of digital data files, which are accessed, created, modified, received, or transmitted by the PC and includes a trusted time source in a tamperproof environment. The PC system and methods apply to multiple document types and include an unalterable trusted time source, temporal storing of digital content, digital signature, hashing, and certificate production.

U.S. Pat. No. 6,948,069 discloses a system and methods for proving dates of digital-imaging files, which are accessed, created, modified, received, saved, or transmitted by a computer and includes a trusted time source in a tamperproof environment. The system and methods apply to digital imaging files and include a trusted time source, digital signature, hashing, and certificate production.

U.S. Pat. No. 6,965,998 discloses a time-stamping protocol for time-stamping digital documents using a time-based signature key. The protocol generally includes a time stamping authority using a time-based key to sign time-stamp receipts.

U.S. Pat. No. 6,993,656 discloses a method for time stamping a digital document wherein the document originator creates a time stamp receipt by combining the document or other identifying data and a digital time indication. The method generally includes a time stamping authority using a time-based key and aged time-stamp receipts.

U.S. Pat. No. 7,006,632 discloses a self-authenticating check authorization system and method that includes a check that has standard bank and account information printed on the MICR line, as well as a one-way hash value that is computed based on the standard bank and account information as well as a personal identification code of a customer.

U.S. Pat. No. 7,082,538 and U.S. Patent Publication No. 2002/0091928 disclose a secure messaging system that encrypts an electronic document using a symmetric key and transmits the encrypted document and related message parameters to a recipient whose identity is then authenticated by a web server. The system include symmetrical keys produced by a web server after correct authorization, authentication of content by recipient via a web server, time-stamping, linked hashing to produce an audit trail, and existence verification.

U.S. Patent Publication No. 2005/0081033 discloses a method for protecting data that includes the steps of: assigning in the IT system of an author user, digital conditioning attributes of the data, corresponding to at least one predetermined event that is liable to affect the data in future use, attributing in the IT system, information that secures data integrity, setting up in the IT system, an envelope file carrying data, digital conditioning attributes affected to the data and information that secures data integrity, storing in a remote IT system, digital conditioning attributes affected to the data and information that secures data integrity, for each predetermined event related to the data, storing in the remote IT system an identifier of the event and its date, and at each connection, storing predetermined events corresponding to data attributes, in the IT system of the author, so that the IT system keeps track, for each event regarding data, the identifier of the event, the identifier of the user at the origin of the event and its date. The method generally includes user identification utilization, public-key encryption, time stamping, and other authentication techniques.

U.S. Patent Publication No. 2006/0053294 discloses a method for monitoring and saving data records in a monitored system with the purpose of preventing the possibility to tamper with said data records at a later time. The method generally includes tamper prevention once a record has been completed, a time-limited active key, and one-way encryption.

### BRIEF SUMMARY OF THE INVENTION

Briefly described, in preferred form, the present invention is a system and method combining registration with a trusted third party, certificate generation, hashing, encryption, customizable file identification fields, and time-stamping technology with recognized “best practice” procedures to achieve the legal admissibility and evidential weight of any form of digital file or collection of digital files. Generally, the originator of the file (the first party) and the originator's employing organization are registered with a Trusted Third Party. The originator reduces the file, by means of a hashing algorithm, to a fixed bit length binary pattern. This provides a unique digital fingerprint of the file. The resultant hash value, the originator's identity details, the employing organization details associated and securely linked to the digital certificate, the title of the file, customizable file identification fields, and other relevant data are forwarded to a Trusted Third Party where the date and time from a known and trusted time source are added. The customizable file identification fields can provide the originator with a mechanism for configuring the seal to incorporate as much additional information as deemed necessary to prove the authenticity of the digital content and/or provide data for the purposes of adding value in functions such as source identification, sorting, analysis, investigation, and compliance. Such information could include, but would not be limited to, location/GPS coordinates, machine id, biometric information, smart-card data, reason for sealing. The original file does not leave the control of the originating party. When combined, the forwarded details and date and time create a Seal Record. The Seal Record is encrypted and hashed. The Seal Record along with all other relevant information is retained on a central secure server. The recipient of the file (the second party) can confirm the file has been received in an unaltered state with integrity retained and it is the authentic version by validating the file.

Validating the sealed file requires the recipient to reproduce the hash value for the encrypted Seal Record and compares it with the stored hash value of the encrypted Seal Record. If this comparison is successful, the recipient reproduces the hash value of the file content, the digital fingerprint, and returns the encrypted Seal Record, the reproduced hash value of the file content along with all other relevant information to the Trusted Third Party. The Trusted Third Party decrypts the encrypted Seal Record received from the second party, retrieves the Seal Record of the first party from the secure server, and compares the second party's content with the corresponding information stored within the Seal Record of the first party. If the values presented by the second party match the securely-stored information generated by the original sealing party, then a determination is made that the content has not been altered. The Trusted Third Party returns the details of the appropriate Seal Record to the second party as confirmation of the file's integrity and authenticity.

The present invention provides a method whereby the recipient or recipients of the sealed digital file may apply a seal onto the previously sealed file as a way of “counter-signing” the file. Future validation of the sealed file would indicate all parties who have applied their seal to the previously sealed document thus providing a chain of evidence.

The present invention provides a combination of appropriate technology and best practice procedures to achieve various advantageous goals including, but not limited to establishing beyond a reasonable doubt that the originator of the digital content is who they claim to be, establishing beyond any practical doubt that the content of the data file has not been altered, freezing the identity and known content of the data file at a given point in time (e.g., when the content is sealed), providing an irrefutable and unimpeachable time reference to be used for proper time-stamping, securely storing all data for future reference, and validating the content and time in an easily accessible manner. The present invention can be successfully incorporated into any electronic system where the establishing of legal admissibility and evidential weight is required to support the integrity or authenticity of the subject data file. Deployment can cover, not exclusively, e-mail text based documents, drawings, video images or audio in real time or from recordings or database content. In another embodiment, the invention can be used to create secure audit trails of activity over a time period.

These and other objects, features and advantages of the present invention will become more apparent upon reading the following specification in conjunction with the accompanying drawings.

### BRIEF DESCRIPTION OF THE FIGURES

FIG. 1 illustrates a block diagram representation of component structures of a validation and authentication system in accordance with preferred embodiments of the present invention.

FIG. 2 illustrates a block diagram representation of a computing environment, which may be utilized in accordance with preferred embodiments of the present invention.

FIG. 3 illustrates a logic flow diagram representing a method of sealing digital content in accordance with preferred embodiments of the present invention.

FIG. 4 illustrates a logic flow diagram representing a method of validating sealed digital content in accordance with an exemplary embodiment of the present invention.

FIG. 5 illustrates a logic flow diagram representing a method of extracting sealed digital content in accordance with an exemplary embodiment of the present invention.

### DETAILED DESCRIPTION OF THE PREFERRED EMBODIMENTS

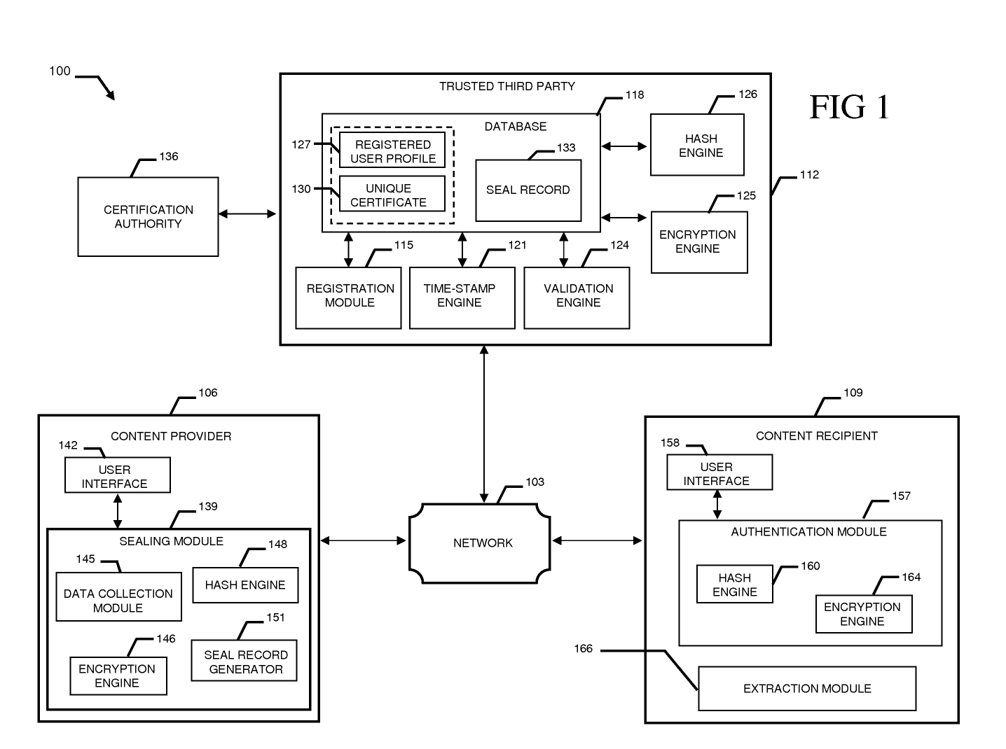

Referring now in detail to the drawing figures, wherein like reference numerals represent like parts throughout the several views, FIG. 1 displays component structures of a validation and authentication system 100 for validating and authenticating digital content from a potentially unverified source to ensure digital content is not tampered with or corrupt. The validation and authentication system 100 assist in retaining the legal admissibility and evidential weight of the digital content. The present invention provides a considered and holistic security approach to ensure that received digital content can be trusted and represents the true intention of the originator of the digital content.

The validation and authentication system 100 of the present invention provides technical components that have been developed to meet “best practice” procedures and security requirements of an established series of codes or practices (e.g., the British Standards Institute Codes of Practice, International Standards Organization, American National Standards Institute). Functionally, the technical components, described more fully below, provide a robust and secure management system that can identify the originator of the digital content, evaluate the content of the digital content at the time of sealing, append an irrefutable date and time to the seal activity, optionally add additional information at time of sealing including, but not limited to, location/GPS coordinates, machine id, biometric information, smart-card data, reason for sealing, optionally add a statement regarding the solution deployed, independently validate the veracity of the seal via a trusted third party, and secure all sealing transactions to the highest industry standards.

The codes or practices provide a policy framework for the deployment of the technical components of the present invention. Moreover, the technical components that regulate identity, data file content, time, the optional data including, but not limited to, location/GPS coordinates, machine id, biometric information, smart-card data, reason for sealing, and explanation of methodology meet or exceed key technical requirements as provided by the codes or practices. The ability to independently and securely validate the veracity of sealed digital content with a trusted third party also meets and exceeds requirements as provided by the codes or practices. The present invention provides a strong security environment that ensures that once sealed, the seal record cannot be deleted, altered, or amended and a new record cannot be inserted. Accordingly, the integrity of the overall system is maintained. The validation and authentication system 100 of the present invention provides the necessary structures for audit trail and usage management.

The invention is designed to meet the growing requirements in multiple industries where electronic transactions take place. As such, the present invention has been developed taking the “best practices” from a policy perspective and combining them with the appropriate technology in a unique manner to meet any application where non-repudiation is required. Generally, the validation and authentication system 100 provides the answers to the “who”, “what”, “when”, “where”, and “why” questions associated with verifying digital content. From the highest level the invention provides ubiquitous solution in many areas of electronic transactions including, but not limited to, non-repudiation of banking transactions using banking applications, non-repudiation of retail transactions in retailing applications, attaching evidential weight to video images gathered from closed-circuit television (CCTV) applications, meeting the data integrity requirements of HIPAA under the Final Security Ruling, protecting and demonstrating ownership in intellectual property rights or copyright disputes, demonstrating clearly the legal standards of financial transactions as required by Sarbanes Oxley and other regulatory legislation, providing proof of originality under the Data Protection and Freedom of Information legislation, and providing proof of transaction activity during any stage of a workflow process.

As illustrated in FIG. 1, the validation and authentication system 100 generally comprises a content provider (i.e.: the person sealing the data) 106, a content recipient (i.e.: the person receiving the sealed data) 109, and a trusted third party (i.e.: the independent party providing the ability to seal the data) 112 connected together via a communication network 103 (also referred to as “network 103”). One skilled in the art will recognize that the network 103 typically contains the infrastructure and facilities appropriate to connect the content provider 106, content recipient 109, and trusted third party 112 (including, without limitation, a number of computer system in communication with each other).

The network 103, content provider 106, content recipient 109, and trusted third party 112 can be configured in multiple network topologies including, but not limited to, star, bus, or ring configurations. Also, the network 103, content provider 106, content recipient 109, and trusted third party 112 can be broadly categorized as belonging to a particular architecture including, but not limited to, peer-to-peer or client/server architectures. The network 103 can additionally be classified by the geographical location of the content provider 106, content recipient 109, and trusted third party 112. For example, if the network 103 connects a number of computer systems or servers located in relatively close proximity to each other, such as within a building, the network 103 is referred to as a local-area network (LAN). If the computer systems are located farther apart, the network 103 is generally referred to as a wide-area network (WAN), such as the Internet. If the computer systems are located within a limited geographical area, such as a university campus or military establishment, the network 103 is referred to as a campus-area network (CAN). Similarly, if the computer systems are connected together within a city or town, the network 103 is referred to as a metropolitan-area network (MAN). Finally, if the computer systems are connected together within a user's home, the network 103 is referred to as a home-area network (HAN).

The content provider 106 generally includes a sealing module 139 adapted to adequately seal digital content and a user interface 142 for receiving instructions or additional data from a user during the sealing process of the digital content. Accordingly, the sealing module 139 may be used to validate that the content provider 106 is registered with the trusted third party 112, create a hash value (digital fingerprint) of the digital content, collect additional information relevant to sealing the digital content, interact with the trusted third party 112 to process the sealing request, and package the digital content with the generated seal information into a digital envelope, generally denoted by a “.tru” file extension. Alternatively, the digital content may remain separate from the digital envelope (the “.tru” file) containing the generated seal information. The sealing module 139 does not require the content provider 106 to transmit the original digital content the trusted third party 112. The sealing module 139 of the content provider 106 can include a data collection module 145 in communication with the user interface 142, a seal record generator 151, an encryption engine 146, and an associated hash engine 148.

The data collection module 145 is generally adapted to collect information to be used in the sealing process of digital content. Such information (mandatory or optional) can include, but is not limited to, local machine time, details about the originator (e.g., user/author of the digital content), details about the employing organization (e.g., details about the company authoring the digital content), title of the digital content and associated metadata, previously sealed files (if applicable), reason for sealing the digital content, details about the content provider 106, details of the location of the digital content (such as GPS coordinates), and other useful details (such as biometric data, smart-card data, machine id or internet protocol addressing data). The information collected by the data collection module 145 can be incorporated by the sealing module 139 into a seal record of the digital content. The collected information can later be used to authenticate or validate the sealed digital content. Indeed, the sealing module 139 collates the collected data into a standard format and produces a partial seal record of the digital content. Furthermore, the data collection module 145 can be adapted to collect information from the content provider 106 (via the user interface 142), directly from the content provider's processing environment, or from any form of electronic data collection (such as GPS or biometric scanner), which can be integrated with the data collection module 145.

The user interface 142, which can be any form of electronic data manipulation application, is utilized to receive data from a user and provide the received data to the data collection module 145 for processing. One skilled in the art will recognize that the user interface 142 may be designed in a variety of embodiments and formats and may range from a simple to a more complex configuration. Further, the user interface 142 can be configured so that each user of the validation and authentication system 100 is capable of providing custom information, including, but not limited to, location/GPS coordinates, machine id, biometric information, smart-card data, reason for sealing the digital content, to the data collection module 145.

The hash engine 148 is adapted to analyze the digital content to be sealed and produce a unique hash value (e.g., part of a seal record). The unique hash value can be incorporated by the sealing module 139 into the seal of the digital content, so that the hash value can subsequently be used as part of the process to determine whether the digital content has changed since it had been sealed. One skilled in the art will recognize that the hash engine 148 can utilize various hashing algorithms (having various levels of encryption strength) such as, but not limited to, the secure hash algorithm (SHA), the message-digest (MD) algorithm, or the cyclic redundancy check (CRC) algorithm. The seal record generator 151, the hash engine 148 and the trusted third party 112 provide a unique seal record, in a predefined format, that can be associated with the digital content file.

The encryption engine 146 is adapted to integrate with available standard encryption methods as an optional means for the content provider 106 to encrypt the original digital content as part of the sealing process.

The content recipient 109 generally includes an authentication module 157, an extraction module 166, a hash engine 160, an encryption engine 164, and a user interface 158 for receiving instructions or additional data from a user during the validation process of the digital content. When a content recipient 109 receives an envelope folder containing sealed digital content, the content recipient 109 has the ability to authenticate the digital content (using the trusted third party 112) and to extract the digital content from the envelope folder so that the user of the content recipient 109 can utilize the digital content as it was intended. Accordingly, the authentication module 157 includes an encryption engine 164 and an associated hash engine 160. The hash engine 160 generally utilizes the same or similar hash algorithm used by the hash engine 148 of the sealing module 139. The hash engine 160 creates local or new hash values from the received (sealed) digital content and the received encrypted seal record associated with the digital content. A comparison can be made by the authentication module 157 (using the trusted third party 112) as to whether the local or new hash values match the hash values associated with the originally sealed digital content securely store with the trusted third party 112. Whether the content recipient 109 authenticates the received sealed digital content or not, the extraction module 166 is adapted to extract the original digital content from the seal and envelope folder. If the digital content was encrypted by the content provider 106, the content recipient 109 may use the encryption engine 164 to decrypt the digital content. The user of the content recipient 109 can then use the digital content as desired.

The trusted third party 112 generally comprises a registration module 115, a time-stamp engine 121, a validation engine 124, a hash engine 126, an encryption engine 125, and a database 118. The trusted third party 112 may also include or optionally control a certification authority 136, which is adapted to provide a unique digital certificate when requested by the trusted third party 112.

The registration module 115 is adapted to register an originator or author of digital content (e.g., the user of the content provider 106). The registration process of the registration module 115 includes the collection of user information to create a registered user profile 127, which can be stored in the database 118. Further, the registration module 115 requests and receives a unique certificate 130 from the certification authority 136, so that the unique certificate 130 can be allocated and associated with the registered user profile 127. Accordingly, the unique certificate 130 can be stored in the database 118 with the registered user profile 127. The unique certificate 130 can be used by the trusted third party 112 to certify the sealed digital content. For example, the trusted third party 112 can use the unique certificate 130 when incorporating the sealed digital content into an envelope folder.

The time-stamp engine 121 is adapted to receive sealed digital content from the content provider 106. The time-stamp engine 121 uses an irrefutable time source in order to provide a secure time-stamp during the sealing process of the received sealing data derived from the seal record generator 151. The content provider 106 may locally seal the digital content. The time-stamp engine 121 of the trusted third party 112 can be used to time-stamp the part of the seal record produced by the output of the seal generator 151 and the unique certificate 130.

The encryption engine 125 is adapted to encrypt the seal record 133 and the hash engine 126 is adapted to produce a hash of the encrypted seal record. A copy of the seal record 133 along with all other relevant information can be stored in the database 118, such that it is associated with the registered user profile 127 of the author of the digital content. This embodiment can also generate a unique record identification number to be incorporated into the seal record 133.

The validation engine 124, which does not necessarily have to permanently reside on a computer, is adapted to receive the hash value of the encrypted seal record, the hash value of the digital content, the encrypted seal record, and all other relevant information from the content recipient 109. The validation engine 124 can determine whether the provided values match the stored values of the seal record 133 stored in the database 118, as well as further determine whether the sealed digital work is authentic and whether it has or has not been tampered with. Accordingly, the validation engine 124 can invoke the encryption engine 125 to decrypt the encrypted seal record received from the content recipient 109. The validation engine 124 can retrieve the originally stored seal record 133 and all other relevant information from the database 118 in order to adequately determine whether the sealed digital content received by the content recipient 109 is indeed authentic and valid. The validation engine 124 provides a status message to the content recipient 109 instructing a user as to whether the sealed digital content received by the content recipient 109 is trustworthy or not.

One skilled in the art will recognize that the content provider 106, content recipient 109, trusted third party 112, certification authority 136 and components thereof can be configured with hardware and/or software appropriate to perform the tasks and provide capabilities and functionality as described herein.

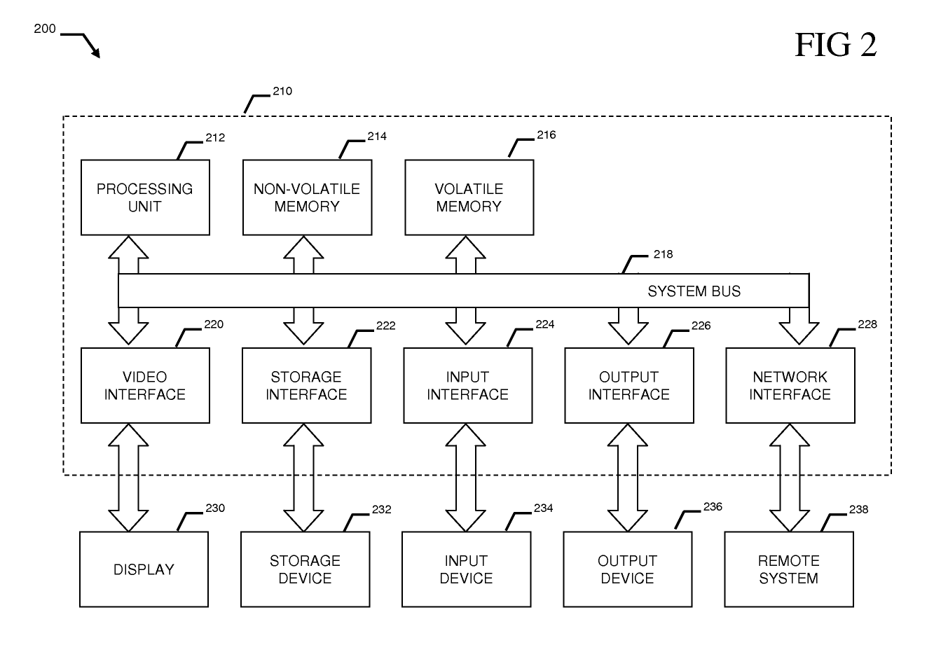

FIG. 2 displays a block diagram representation of a computing environment 200 which may be utilized in accordance with preferred embodiments of the present invention. More particularly, content provider 106, content recipient 109, and trusted third party 112 can utilize the computing environment 200 described herein. The content provider 106, content recipient 109, and trusted third party 112 of the present invention can include, but are not limited to, personal computers, mainframe computers, servers, hand-held or laptop devices, cellular phones, multiprocessor systems, microprocessor-based systems, set-top boxes, programmable consumer electronics, network PCs, minicomputers, distributed computing environments that include any of the above systems or devices, and the like. It should be understood, however, that the features and aspects of the present invention can be implemented by or into a variety of systems and system configurations and any examples provided within this description are for illustrative purposes only.

FIG. 2 and the following discussion provide a general overview of a platform onto which an embodiment of the present invention, or portions thereof, can be integrated, implemented and/or executed. Although reference has been made to instructions within a software program being executed by a processing unit, those skilled in the art will understand that at least some of the functions performed by the software can also be implemented by using hardware components, state machines, or a combination of any of these techniques. In addition, a software program which may implement an embodiment of the present invention can also run as a stand-alone program or as a software module, routine, or function call, operating in conjunction with an operating system, another program, system call, interrupt routine, library routine, or the like. The term program module is used herein to refer to software programs, routines, functions, macros, data, data structures, or any set of machine readable instructions or object code, or software instructions that can be compiled into such, and executed by a processing unit 212.

Turning now to the figure, computing device 210 may comprise various components including, but not limited to, a processing unit 212, a non-volatile memory 214, a volatile memory 216, and a system bus 218. The non-volatile memory 214 can include a variety of memory types including, but not limited to, read only memory (ROM), electronically erasable read only memory (EEROM), electronically erasable and programmable read only memory (EEPROM), electronically programmable read only memory (EPROM), electronically alterable read only memory (EAROM), FLASH memory, bubble memory, battery backed random access memory (RAM), compact disc read only memory (CDROM), digital versatile disc (DVD), or other optical disk storage, magnetic cassettes, magnetic tape, magneto-optical storage devices, magnetic disk storage or other magnetic storage devices, or any other medium which may be used to store the desired information. The non-volatile memory 214 can provide storage for power-on and reset routines (bootstrap routines) that are invoked upon applying power or resetting the computing device 210. In some configurations the non-volatile memory 214 can provide the basic input/output system (BIOS) routines that are utilized to perform the transfer of information between elements within the various components of the computing device 210.

The volatile memory 216 can include a variety of memory types and devices including, but not limited to, random access memory (RAM), dynamic random access memory (DRAM), synchronous dynamic random access memory (SDRAM), double data rate synchronous dynamic random access memory (DDR-SDRAM), bubble memory, registers, or the like. The volatile memory 216 can provide temporary storage for routines, modules, functions, macros, data, etc. that are being or may be executed by, or are being accessed or modified by, the processing unit 212.

Alternatively, the non-volatile memory 214 and/or the volatile memory 216 can be a remote storage facility accessible through a distributed network system. Additionally, the non-volatile memory 214 and/or the volatile memory 216 can be a memory system comprising a multi-stage system of primary and secondary memory devices, as described above. The primary memory device and secondary memory device can operate as a cache for each other or the second memory device can serve as a backup to the primary memory device. In yet another embodiment, the non-volatile memory 214 and/or the volatile memory 216 can comprise a memory device configured as a simple database file or as a searchable, relational database using a query language, such as SQL.

The computing device 210 can access one or more external display devices 230 such as a CRT monitor, LCD panel, LED panel, electro-luminescent panel, or other display device, for the purpose of providing information or computing results to a user. In some embodiments, the external display device 230 can actually be incorporated into the product itself. For example, the computing device 210 can be a mobile device having a display device 230. The processing unit 212 can interface to each display device 230 through a video interface 220 coupled to the processing unit 210 over the system bus 218.

In operation, the computing device 210 sends output information to the display 230 and to one or more output devices 236 such as a speaker, modem, printer, plotter, facsimile machine, RF or infrared transmitter, computer or any other of a variety of devices that may be controlled by the computing device 210. The processing unit 212 can interface to each output device 236 through an output interface 226 coupled to the processing unit 212 over the system bus 218.

The computing device 210 can receive input or commands from one or more input devices 234 such as, but not limited to, a keyboard, pointing device, mouse, modem, RF or infrared receiver, microphone, joystick, track ball, light pen, game pad, scanner, camera, computer or the like. The processing unit 212 may interface to each input device 234 through an input interface 224 coupled to the processing unit 212 over the system bus 218.

It will be appreciated that program modules implementing various embodiments of the present invention can be stored in the non-volatile memory 214, the volatile memory 216, or in a remote memory storage device accessible through the output interface 226 and the input interface 224. The program modules can include an operating system, application programs, other program modules, and program data. The processing unit 212 can access various portions of the program modules in response to the various instructions contained therein, as well as under the direction of events occurring or being received over the input interface 224.

The computing device 210 can provide data to and receive data from one or more other storage devices 232, which can provide volatile or non-volatile memory for storage and which can be accessed by computing device 210. The processing unit 212 can interface to each storage device 232 through a storage interface 222 over the system bus 218.

The interfaces 220, 222, 224, 226, and 228 can include one or more of a variety of interfaces, including but not limited to, cable modems, DSL, T1, T3, optical carrier (e.g., OC-3), V-series modems, an RS-232 serial port interface or other serial port interface, a parallel port interface, a universal serial bus (USB), a general purpose interface bus (GPIB), an optical interface such as infrared or IrDA, an RF or other wireless interface such as Bluetooth, and the like.

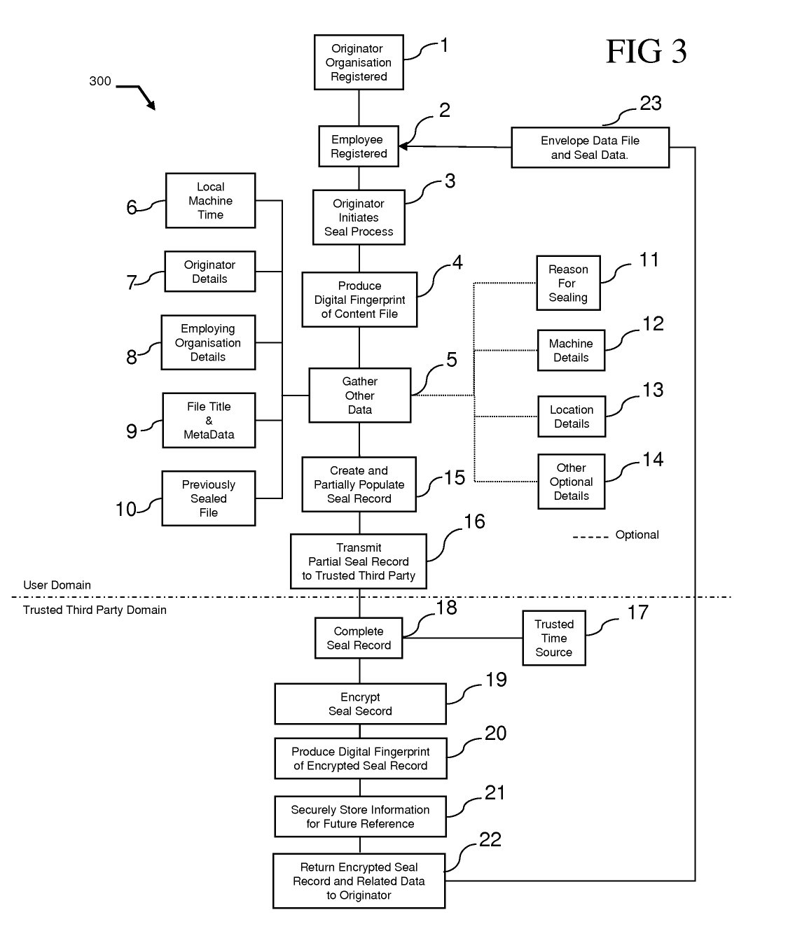

FIG. 3 illustrates a logic flow diagram representing a method 300 of sealing digital content provided by the user interface 142 in accordance with preferred embodiments of the present invention. The method 300 of the present invention allows for all types of digital content to be properly sealed so that the content recipient 109 can validate and authenticate the sealed digital content to ensure that it has not been tampered with or corrupt. Accordingly, the digital content can retain legal admissibility and evidential weight, if necessary, because the digital content's authenticity can be verified.

More specifically, the method 300 of sealing digital content begins at 1 where the content provider 106 (e.g., the originator organization) registers with the trusted third party 112 as an authorized user. Registration of the content provider 106 with the trusted third party 112 includes the creation of an account with the trusted third party 112 via the registration module 115. The registration module 115 of the trusted third party 112 generates a registered user profile 127 to be stored on a database 118 of the trusted third party 112. The registration module 115 can further allocate and associate a unique digital certificate 130 with the registered user profile 127. Generally, the trusted third party 112 owns or controls a secure certification authority 136, which provides the unique digital certificate 130 when requested by the registration module 115.

In an alternative embodiment of the present invention, the content provider 106 at 2 may opt to delegate a user (employee registration) to an employee or organization. For example, a digital certificate could be allocated to the employee or a digital certificate could be allocated to an organization, wherein an employee could have access to it during the sealing process.

Next at 3, the content provider 106 utilizes the user interface 142 to initiate the sealing process. The content provider 106 selects the digital content or collection of digital content to seal. The sealing module 139 utilizes information from the content provider's 106 profile created during the registration process at 1 to verify that the content provider 106 is registered with the trusted third party 112.

At 4, the seal record generator 151 creates the seal record in a standard format (one such embodiment being XML) that will be populated at various points during the sealing process with information related to the digital content being sealed. The seal record generator 151 generally utilizes a hash engine 148 that applies a hashing algorithm such as, but not limited to, secure hash algorithm (SHA) 256, to the digital content. The seal record generator 151 and hash engine 148, therefore, provide a unique, standard format digital fingerprint that is associated with the digital content file (e.g., the “What” and part of the “Who”). The hash value of the digital content and information from the content provider's 106 profile are added to the partial seal record by the sealing module 139.

At 5, the sealing module 139 then gathers secondary information through the data collection module 145. The data collection module 145 generally collects the local machine time at 6, the originator details (e.g., part of the “Who”) at 7, the employing organization details (e.g., part of the “Who”) at 8, the file title and associated meta data at 9, and any previously sealed file data at 10. Further, the data collection module 145 can optionally obtain additional information such as the reason for sealing (e.g., the policy “Why” this digital content has been sealed, such as Sarbanes Oxley, HIPAA, or FOI compliance reasons) at 11, details of the machine used to seal the digital content (e.g., part of the “Where”) at 12, location data (e.g., part of the “Where”) at 13 and other data including, but not limited to biometric data (e.g., part of the “Who”), smart-card data, or internet protocol (IP) addressing data (e.g., part of the “Where”) at 14. An embodiment of the data collection module 145 is designed in a generic manner, which enables it to generate any number of name/value pairs, whereby the name is the data field name (e.g.: GPS Location) and the value is the data field value (e.g.: data representing GPS coordinates). This information may be collected directly by the data collection module 145, by any form of electronic data collection which can be integrated with the data collection module 145, or the user interface 142 can assist the sealing module 139 in collecting, from the content provider 106, various information to be used in sealing the digital content. For example, the user of the content provider 106 may be prompted by the user interface 142 to provide a reason for why the digital content is being sealed. These customizable name/value pairs may provide the content provider 106 with a mechanism for configuring the sealing module 139 such that the data collection module 145 could collect as much information as deemed necessary to prove the authenticity of the digital content and/or provide data for the purposes of adding value in functions such as source identification, sorting, analysis, investigation, and compliance. For example, the content provider 106 may wish to strengthen the authenticity and evidential weight of a document by requiring that the originating party 106 seal the document with GPS location data in order to identify the geographic location where there digital content was sealed. At 15, the sealing module 139 and seal record generator 151 collate the collected data and add that information to the partial seal record. At 16, the partial seal record, generally containing the P7m digital signature (including a hash and local time from the content provider), the hash value (digital fingerprint) of the digital content, the filename of the digital content, longevity information (e.g.: version, technology, sealing toolkit), all name/value pairs containing information collected from the content provider 106 by the data collection module 145, and any other relevant information generated by the sealing module 139 are securely transmitted to the trusted third party 112. For the purposes of meeting a higher level of desired security, an embodiment of the sealing module 139 may require the content provider 106 to provide additional information in order to log into the trusted third party 112 before the content provider 106 securely transmits information to the trusted third party 112.

On receipt of the data, the trusted third party 112 time stamps the data via a time-stamp engine 121. At 17, the time-stamp engine 121 utilizes an unimpeachable time source that is, for example, referenced to coordinated universal time (UTC), thereby ensuring accuracy. The trusted third party 112 then completes the seal record 133 at 18 by adding the unique time-stamp generated by the third party time stamp engine 121 to the seal record. The completed seal record, in a standard format (one such embodiment being XML), generally contains the P7m digital signature (including a hash and local time from the content provider), the hash value (digital fingerprint) of the digital content, the filename of the digital content, longevity information (e.g.: version, technology, sealing toolkit), the unique certificate 130 associated with the content provider 106 or user, all name/value pairs containing information collected from the content provider 106 by the data collection module 145, and the unique identification number associated with the seal record 133 in the trusted third party database 118. The completed seal record is encrypted at 19 and the encrypted seal record is then hashed at 20. Generally, a copy of the unencrypted seal record 133, the hash value of the digital content, the name/value pairs used to store additional information gathered by the data collection module 145, sealing time established by the time-stamp engine 121, the number of digital files contained in the seal (indicating the number of files in a collection of digital content), longevity information (e.g.: version, technology, sealing toolkit), and any other information related to the sealing process are securely stored in the database 118 of the trusted third party 112 at 21 for future reference. Additionally, the seal record 133 stored within the database 118 can be associated with the content provider's registered user profile 127 and information related to the content provider's designated employee.

At 22, the trusted third party 112 securely returns the encrypted seal record, the hash value of the encrypted seal record, the server address of the trusted third party 112 and any other relevant information to the content provider 106.

At 23, the sealing module 139 utilizes the encryption engine 146 to encrypt the server address of the trusted third party 112 (so that it may be incorporated into the seal in a non-viewable format), and then envelopes the original content file, the encrypted seal record, the hash value of the encrypted seal record, the encrypted server address of the trusted third party 112 and any other relevant information into a seal folder, generally referred to as the “.tru” file. Optionally, the original data file can be encrypted prior to being enveloped into a folder at 23. The seal folder (the “.tru” file) is provided to content provider's 106 employee or originator so that they can freely store it according to existing policy rules or transmit the enveloped folder (the “.tru” file) to another party, such as the content recipient 109. The content provider 106 can at 3 repeat the process to seal additional digital content or can terminate the process in accordance with method 300 of the present invention.

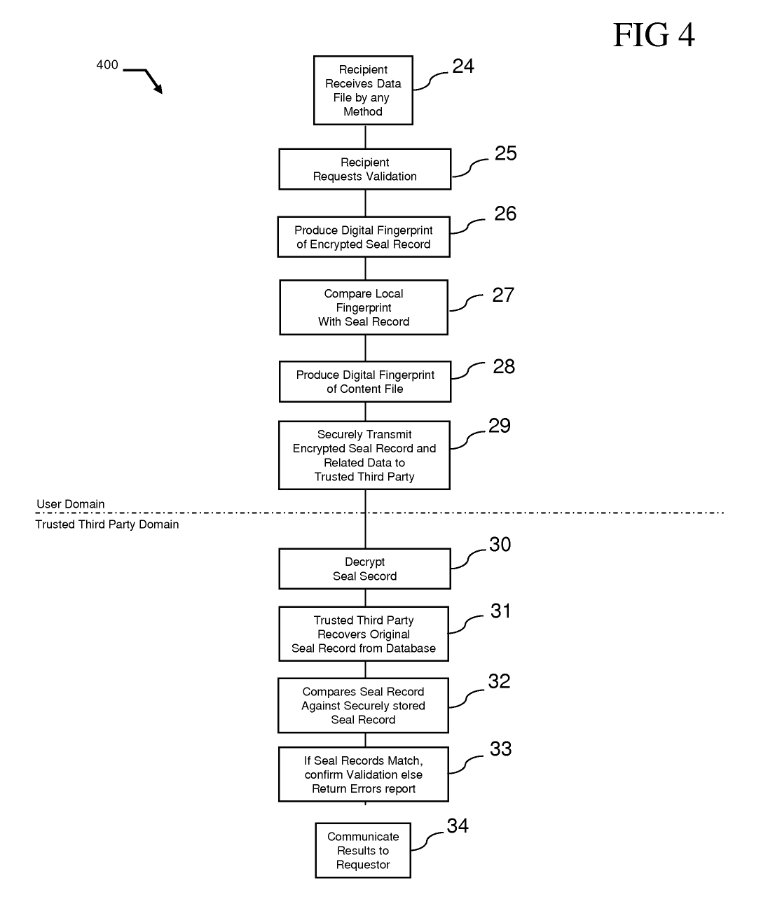

FIG. 4 illustrates a logic flow diagram representing a method of validating sealed digital content in accordance with an exemplary embodiment of the present invention. The method 400 of the present invention allows for the proper validation of previously sealed digital content, so that a content recipient 109 can determine whether the received digital content is authentic and whether the digital content has been corrupted or tampered with. If the content recipient 109 can ensure that the received digital content is the true original, then the digital content can be considered valid for legal admissibility and evidential weight.

More specifically, the method 400 of validating digital content begins at 24 where the content recipient 109 receives an enveloped folder from a content provider 106 (e.g., the originator). The enveloped folder (generally referred to as the “.tru” file) typically contains the original content file, the encrypted seal record, the hash value of the encrypted seal record, the encrypted server address of the trusted third party 112 and any other information related to the sealing process 300. Within the enveloped folder, the encrypted seal record typically contains the P7m digital signature (including a hash and local time from the content provider 106), the hash value (digital fingerprint) of the digital content, the filename of the digital content, longevity information (e.g.: version, technology, sealing toolkit), the unique certificate 130 associated with the content provider 106 or user, all name/value pairs containing information collected from the content provider 106 by the data collection module 145, and the unique identification number associated with the seal record 133 in the trusted third party database 118. In order to properly validate the received enveloped folder, the content recipient 109 requests at 25 an authentication module 157 to validate the data file associated or enclosed in the received enveloped folder. At 26, the authentication module 157 engages a hash engine 160, utilizing a similar hash algorithm as used by the trusted third party 112 when sealing the digital content, to produce a local copy of the hash value of the encrypted seal record enclosed in the received enveloped folder.

Then at 27, the authentication module 157 of the content recipient 109 makes a comparison of the locally produced hash value of the encrypted seal record and the corresponding hash value enclosed and transmitted within the enveloped folder. If the two hash values do not match, then the authentication module 157 alerts the user of the content recipient 109 that the received enveloped folder and associated digital content are invalid and untrustworthy.

If, however, at 27, the authentication module 157 determines that the local hash value of the encrypted seal record matches the hash value of the encrypted seal record stored in the sealed envelope folder, then the authentication module 157 engages a hash engine 160, utilizing a similar hash algorithm as used by the content provider 106 when sealing the digital content, to produce a local copy of the hash value from the content of the data file at 28.

Then at 29, the content recipient 109 engages the encryption engine 164 to decrypt the server address of the trusted third party 112 and then securely transmits the encrypted seal record, the locally generated hash value of the digital content, the P7m digital signature, and any other information derived from the authentication module 157 to the trusted third party 112 for further validation.

At 30, the trusted third party 112 invokes the encryption engine 125 to decrypt the encrypted seal record transmitted by the content recipient 109 at 29.

At 31, the trusted third party 112 via a validation engine 124 recovers the original seal record 133 and all other relevant information from the secure database 118, which was previously stored by the trusted third party 112 during the sealing process conducted by the content provider 106. The validation engine 124 at 32 conducts a comparison of the seal record information received from the content recipient 109 against the seal record information stored in the secure database 118 of the trusted third party 112. Accordingly, the validation engine 124 compares the hash value of the content file, generated by the authentication module 157 of the content recipient 109 at 28, with the hash value of the content stored in the secure database 118 of the trusted third party 112. Additionally, each element contained in the encrypted seal record received from content recipient 109 and decrypted by the trusted third party 112 at 29 is compared against the unencrypted seal record 133 retained in the secure database 118 of the trusted third party 112. If the validation engine 124 determines at 33 that the seal record and the hash of the digital content received by the content recipient 109 is the same as the stored sealed record 133 and hash value of the digital content previously provided by the content provider 106, then the validation engine generates a success message (indicating that the digital content is valid and authentic) to be provided to the content recipient 109. If, however, at 33, the validation engine 124 determines that the digital content received by the content recipient 109 is invalid, then the validation engine 124 generates an error report.

If the validation was successful, the trusted third party 112 at 34 provides the identity data (e.g., the “Who”), the time data (e.g., the “When”) back to the content recipient 109. Additionally, any other captured data type including, but not limited to, location/GPS coordinates (e.g., the “Where”), machine id, biometric information, smart-card data, reason for sealing the digital content (e.g., the “Why”) could be returned to the content recipient 109 at this time. If, however, the validation was unsuccessful, the trusted third party 112 at 34 provides the error report to the content recipient 109, so that the user of the content recipient 109 knows that the received enveloped file is not to be trusted. Accordingly, since the validation was unsuccessful, the trusted third party 112 does not provide the content recipient 109 with identity data (e.g., the “Who”), the time data (e.g., the “When”), or any other captured data type including, but not limited to, location/GPS coordinates (e.g., the “Where”), machine id, biometric information, smart-card data, reason for sealing the digital content (e.g., the “Why”). The method 400 then terminates in accordance with the present invention.

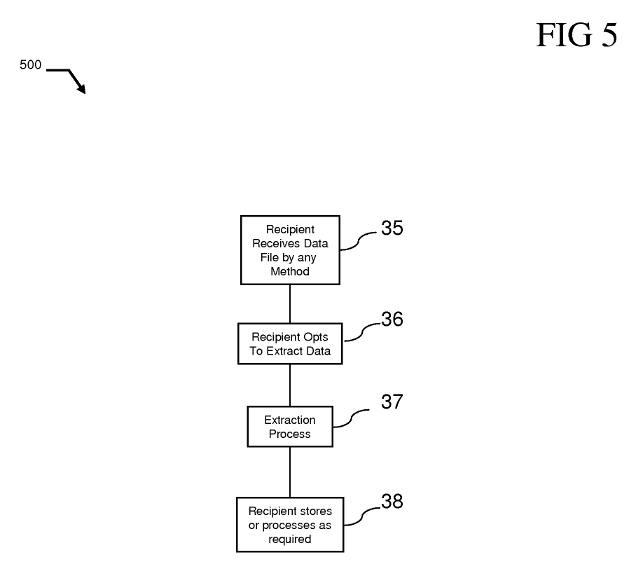

FIG. 5 illustrates a logic flow diagram representing a method 500 of extracting sealed digital content in accordance with an exemplary embodiment of the present invention. The method 500 of the present invention allows for the proper extraction of previously sealed digital content. The content recipient 109 can opt to extract the digital content from a sealed envelope before or after validation of the sealed document has been conducted.

More specifically, the method 500 of extracting digital content begins at 35 where the content recipient 109 receives an enveloped folder from the content provider 106. At 36, the user of the content recipient 109 determines whether to extract the digital content from the enveloped folder (either before or after validation and authentication of the digital content). If at 36, the user of the content recipient 109 determines to extract the digital content from the received enveloped folder, then at 37 the extraction module 166 of the content recipient 109 extracts the data file or files and the associated seal record from the enveloped folder. Optionally, if the file was encrypted, the digital content would be decrypted at 37 the extraction module 166 of the content recipient 109. Generally, the seal record is denoted by a “.tru” file extension, while all other files denoted by their original or native file format extensions, such as, but not limited to, “.doc”, “.ppt”, or “.xls”. At 38, the user of the content recipient 109 can process the original data files extracted from the envelope folder as required or store the extracted data file in line with existing policies. Further, the user of the content recipient 109 can opt to store the received enveloped folder intact. Accordingly, the content recipient 109 can subsequently validate and authenticate the received enveloped folder through the trusted third party 112. The method 500 then terminates in accordance with the present invention.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

What is claimed is:

1. A method for generating an authentication record for digital content and authenticating digital content, the method comprising:
a user selecting a digital content item;
creating a seal record associated with the digital content item;
providing a first hash value for the digital content item;
incorporating the first hash value into the seal record;
acquiring secondary information related to at least one of the digital content item and the user; and
importing secondary information into the seal record.

2. The method of claim 1, further comprising:
transmitting the seal record to a third party;
time-stamping the seal record and including the time-stamp in the seal record;
encrypting the seal record to create an encrypted seal record; and
determining a second hash value for the encrypted seal record.

3. The method of claim 1, the secondary information comprising at least one of local machine time, machine parameters and properties, information relating to the user requesting the digital content item be sealed, information relating to the user's organization, title of the digital content item, metadata of the digital content item, information relating to the reason for sealing the digital content item, geographic location information, smart-card data, internet protocol address data, and biometric information.

4. The method of claim 1, further comprising the user selecting the secondary information that is acquired and imported into the seal record.

5. The method of claim 2, further comprising storing the seal record and the first hash value on a third party database.

6. The method of claim 1, further comprising incorporating at least one of a digital signature, filename of the digital content, and a unique certificate associated with the user into the seal record.

7. The method of claim 2, further comprising receiving from the third party the encrypted seal record, the second hash value and server address of the third party.

8. The method of claim 2, further comprising:
receiving from the third party the encrypted seal record, the second hash value, and a server address of the third party;
encrypting the server address;
associating the digital content item, encrypted seal record, second hash value, and encrypted server address in a transmission file; and
transmitting the transmission file to a recipient.

9. The method of claim 8, further comprising:
the recipient determining a third hash value for the encrypted seal record; and
comparing the second hash value to the third hash value.

10. The method of claim 9, further comprising calculating a fourth hash value for the digital content item if the second and third hash values are determined to be the same.

11. The method of claim 10, further comprising:
decrypting the encrypted server address; and
transmitting to the encrypted seal record and the fourth hash value to the third party.

12. The method of claim 11, further comprising:
the third party decrypting the encrypted seal record received from the recipient;
recovering the seal record stored on the third party database;
comparing the fourth hash value to the first hash value; and
analyzing the content of the encrypted seal record received from the recipient and the seal record stored on the third party database.

13. The method of claim 11, further comprising transmitting the information contained in the seal record to the recipient dependent upon the comparison of the first and fourth hash values and analysis of the encrypted seal record received from the recipient and the encrypted seal record stored on the third party database.

14. The method of claim 8, further comprising the recipient creating a second seal record containing the seal record received from the user and secondary information related to the recipient.

15. The method of claim 1, further comprising:
selecting multiple digital content items;
providing a separate seal record for each selected digital content item, and
providing an additional seal record containing information related to a directory associated with the digital content items.

16. A system for generating an authentication record for digital content and authenticating digital content, the system comprising:
a user interface; and
a sealing module, further comprising:
a seal record generator for creating a seal record associated with a digital content item selected by a user;
a data collection module for acquiring secondary information related to at least one of the digital content item and the user;
a hash engine for providing a first hash value for a digital content item.

17. The system of claim 16, further comprising:
time-stamp engine for time-stamping the seal record and including the time-stamp in the seal record;
an encryption engine for encrypting the seal record to create an encrypted seal record; and
a hash engine for determining a second hash value for the encrypted seal record.

18. The system of claim 16, further comprising an authentication module comprising a hash engine for determining a third hash value for the encrypted seal record a fourth hash value for the digital content item and an encryption engine for decrypting an encrypted server address.

19. The system of claim 17, further comprising a validation engine for comparing a first hash value and a fourth hash value of the digital content item and a second hash value and a third hash value of the encrypted seal record.

20. The system of claim 16, the secondary information comprising at least one of local machine time, machine parameters and properties, information relating to the user requesting the digital content item be sealed, information relating to the user's organization, title of the digital content item, metadata of the digital content item, information relating to the reason for sealing the digital content item, geographic location information, smart-card data, internet protocol address data, and biometric information.

21. The system of claim 16, further comprising a device for collecting secondary information related to attributes of the user.

22. A computer readable medium having computer readable instructions stored thereon for execution by a processor to perform the method of claim 1.
